(19) United States
(12) Patent Application Publication
(10) Pub. No.: US 2013/0104627 A1
(43) Pub. Date: May 2, 2013

(54) KNOCK SENSOR FOR INTERNAL COMBUSTION ENGINE

(71) Applicant: Denso Corporation, Kariya-city (JP)

(72) Inventor: Hirofumi HAGIO, Handa-city (JP)

(73) Assignee: DENSO CORPORATION, Kariya-city (JP)

(21) Appl. No.: 13/664,594

(22) Filed: Oct. 31, 2012

(30) Foreign Application Priority Data
Nov. 1, 2011 (JP) 2011-240014

(51) Int. Cl. G01L 23/22

(52) U.S. Cl. 73/35.11

(57) ABSTRACT

A sensor main body includes a piezoelectric element, which outputs a signal in response to vibration generated from an engine. A sensor support body is configured into a tubular form and supports the sensor main body. The sensor support body has a bolt receiving hole, which extends through the sensor support body and receives a bolt. A protective coating, which is rust resistant and/or corrosion resistant, is formed on an entire surface of the sensor support body. A surface of a corner between a contact surface and a step of the sensor support body is curved or defines an obtuse angle.

### CROSS REFERENCE TO RELATED APPLICATION

This application is based on and incorporates herein by reference Japanese Patent Application No. 2011-240014 filed on Nov. 1, 2011.

### TECHNICAL FIELD

The present disclosure relates to a knock sensor for an internal combustion engine.

### BACKGROUND

A previously proposed nonresonant knock sensor (hereinafter simply referred to as a knock sensor) has a bolt receiving hole, through which the knock sensor is installed to a cylinder block of an internal combustion engine with a bolt received through the bolt receiving hole (see, for example, JP2002-055013A).

With reference to FIG. 4, this knock sensor has a base (support member) 101, which is made of iron-based metal and is configured into a cylindrical tubular form. A bolt is received through a bolt receiving hole 102 of the base 101 and is threadably engaged with a threaded hole formed in a mounting seat of the internal combustion engine. The base 101 includes a sleeve 103, which is configured into a cylindrical tubular form and is placed to surround the bolt. A flange 104, which is configured into an annular form, is formed in an end portion of the sleeve 103 such that the flange 104 radially outwardly extends in a radial direction that is perpendicular to an axial direction of the sleeve 103.

A nut 107, which is made of metal and is formed integrally with a weight 106, is threadably engaged with a male thread 105 of the sleeve 103. The weight 106 presses (urges) a sensor main body, which is installed to the sleeve 103 and surrounds an outer peripheral portion of the sleeve 103.

The sensor main body includes a piezoelectric element 109, two electrode plates 111, 112 and two dielectric plates (insulator plates) 113, 114. The piezoelectric element 109 is configured into an annular form and outputs externally a sensor output signal (voltage signal), which corresponds to vibration of the internal combustion engine. The electrode plate 111 overlaps and contacts one end portion of the piezoelectric element 109. The electrode plate 112 overlaps and contacts the other end portion of the piezoelectric element 109, which is opposite from the one end portion of the piezoelectric element 109. The dielectric plate 113 electrically insulates the weight 106 and the nut 107 from the electrode plate 111. The dielectric plate 114 electrically insulates the flange 104 of the base 101 from the electrode plate 112.

As discussed above, the knock sensor includes the sensor main body installed on the flange 104 of the base 101. The nut 107 threadably and tightly engaged with the male thread 105 of the sleeve 103, so that the sensor main body, which includes the piezoelectric element 109, is securely clamped between the weight 106, which has the nut 107 integrally formed therewith, and the flange 104 of the base 101. Then, this assembly is resin molded with a resin material, which forms a resin-molded body 115.

Here, as shown in FIGS. 5A and 5B, the base 101 has a seat-surface-side contact surface 121. The seat-surface-side contact surface 121 is formed around an opening of the bolt receiving hole 102 of the base 101 such that the seat-surface-side contact surface 121, which is configured into an annular form, contacts a seat surface (a mounting seat surface) of the mounting seat, which is configured into an annular form and is formed around the threaded hole of the mounting seat. A seat-surface-side relief surface 122, which is configured into an annular form, is formed around the seat-surface-side contact surface 121 such that a gap is formed between the seat-surface-side relief surface 122 and the mounting seat surface of the internal combustion engine. The seat-surface-side contact surface 121 axially protrudes from the seat-surface-side relief surface 122 by one step toward the mounting seat surface of the engine. Thereby, an annular step 123 is formed between the seat-surface-side contact surface 121 and the seat-surface-side relief surface 122.

A cross section of a corner (edge) 124 between the seat-surface-side contact surface 121 and the step 123 defines a right angle (i.e., 90 degrees).

In contrast, a cross section of a corner 125 between the seat-surface-side relief surface 122 and the step 123 is configured into a curved recessing surface (an arcuately curved surface that is recessed away from the mounting seat surface of the engine) having a predetermined radius of curvature about a corresponding center point.

The surface of the base 101 is plated (e.g., zinc plated) to improve rust resistance and corrosion resistance of the surface of the base 101.

The knock sensor, which has the above described structure (the base including the corner having the right angle), is fixed to the cylinder block of the engine with the bolt. Thereafter, when the vibration of the cylinder block of the engine is conducted to the piezoelectric element 109 through the base 101, a knock sensor output signal (voltage signal), which has a waveform that corresponds to the vibration of the cylinder block of the engine, is outputted externally from the piezoelectric element 109.

In order to limit erroneous sensing of the knocking of the engine with the knock sensor and thereby to improve the knocking sensing accuracy, it is desirable that the output voltage of the knock sensor does not become significantly large in a specific frequency range (particularly in a high frequency range), and the output voltage of the knock sensor becomes generally flat relative to the vibration frequency.

In order to obtain the stable output voltage, i.e., the generally flat output voltage relative to the vibration frequency from the knock sensor, it is necessary to fix the knock sensor to the engine with the bolt without incompletely installing the knock sensor to the mounting seat surface of the cylinder block of the engine (e.g., without tilting the lower surface of the base 101 of the knock sensor, more specifically the seat-surface-side contact surface 121 of the flange 104 of the base 101 relative to the mounting seat surface of the engine).

However, in the knock sensor of JP2002-055013A, a housing, which forms a mounting surface that is mounted to the mounting seat surface of the engine, is made of iron. In order to improve the rust resistance and the corrosion resistance, a zinc plating (coating) 126 is formed on the surface of the housing.

Furthermore, the cross section of the corner 124 between the seat-surface-side contact surface 121 of the base 101 and the step 123 defines the right angle. That is, the corner of the seat-surface-side contact surface 121 of the base 101 defines the right angle.

Therefore, in the case where the zinc plating 126 is formed on the seat-surface-side contact surface 121 of the base 101, the zinc plating 126, which is formed on the corner 124 between the seat-surface-side contact surface 121 and the step 123, forms a protrusion that protrudes toward the mounting seat surface of the cylinder block of the engine. That is, the protrusion of the zinc plating 126 is formed at the corner 124 of the base 101.

When the portion of the zinc plating 126, which is applied on the surface of the base 101, protrudes, the mounting seat surface of the cylinder block of the engine and the seat-surface-side contact surface 121 of the base 101 do not appropriately match with each other, so that the mounting of the knock sensor to the mounting seat surface of the cylinder block of the engine becomes unstable.

Thereby, as indicated by a dotted line in FIG. 3, a phenomenon (resonance phenomenon), which significantly increases the output signal (voltage) of the knock sensor, occurs. Thus, an abnormality is generated in the output voltage of the knock sensor in the specific frequency range (e.g., the high frequency range). That is, the output voltage of the knock sensor does not become the generally flat output voltage in the specific frequency range (e.g., the high frequency range).

Therefore, in the specific frequency range (e.g., the high frequency range), the vibration generated in the engine may possibly be erroneously sensed with the knock sensor as the knocking vibration, and thereby the knocking sensing range of the knock sensor is disadvantageously narrowed.

Here, it is conceivable to eliminate the application of the zinc plating 126 to avoid the protrusion of the zinc plating 126 by changing the base metal of the base 101 from the iron-based metal to copper-based metal. However, the use of the copper-based metal in place of the iron-based metal having the zinc plating 126 will result in an increase in the costs.

### SUMMARY

The present disclosure addresses the above disadvantages. According to the present disclosure, there is provided a knock sensor for an internal combustion engine. The knock sensor includes a sensor main body and a sensor support body. The sensor main body includes a piezoelectric element. The piezoelectric element outputs a signal in response to vibration generated from the internal combustion engine. The sensor support body is configured into a tubular form and supports the sensor main body. The sensor support body has a bolt receiving hole, which extends through the sensor support body and receives a bolt to fix the sensor support body against a seat surface of the internal combustion engine with the bolt. A protective coating, which is rust resistant or corrosion resistant, is formed on an entire surface of the sensor support body. The sensor support body includes a contact surface, a relief surface and a step. The contact surface circumferentially extends around a peripheral edge of an opening of the bolt receiving hole and contacts the seat surface of the internal combustion engine. The relief surface circumferentially extends along the contact surface. The relief surface is axially recessed away from the contact surface and defines a gap between the relief surface and the seat surface of the internal combustion engine. The step is radially placed between the contact surface and the relief surface and circumferentially extends along the contact surface and the relief surface. A surface of a corner between the contact surface and the step is curved or defines an obtuse angle.

### BRIEF DESCRIPTION OF THE DRAWINGS

The drawings described herein are for illustration purposes only and are not intended to limit the scope of the present disclosure in any way.

FIG. 1 is a cross-sectional view of a knock sensor installed to a cylinder block of an internal combustion engine according to an embodiment of the present disclosure;

FIG. 2A is a partial enlarged view of an area IIA in FIG. 1;

FIG. 2B is a partial enlarged view of an area IIB in FIG. 2A;

FIG. 3 is a diagram showing a relationship between an output voltage and a frequency of vibration for each of the knock sensor of the present embodiment and a knock sensor of a prior art;

FIG. 4 is a cross-sectional view of the knock sensor of the prior art;

FIG. 5A is an enlarged cross-sectional view of an area VA in FIG. 4; and

FIG. 5B is an enlarged cross-sectional view an area VB in FIG. 5A.

### DETAILED DESCRIPTION

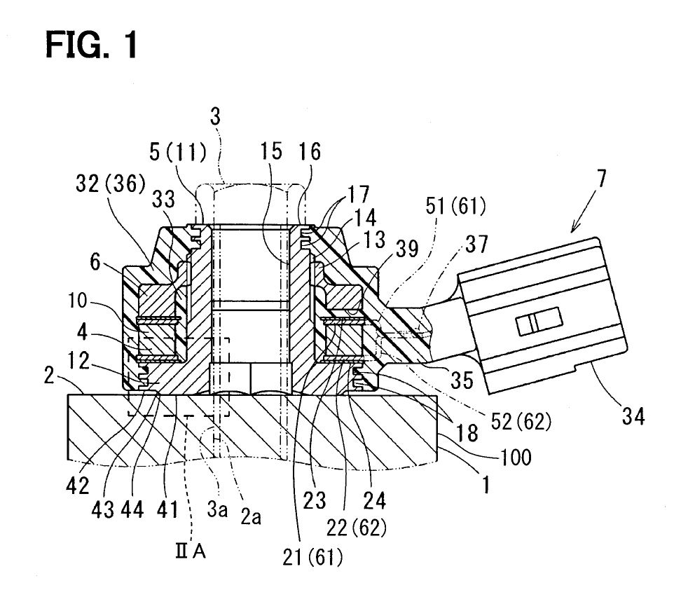

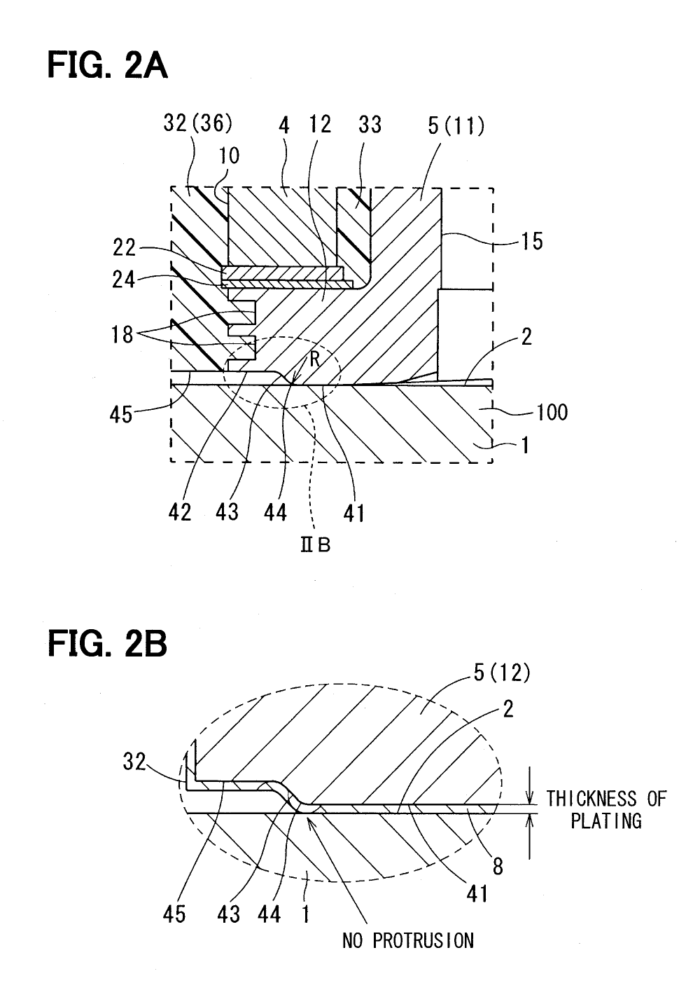

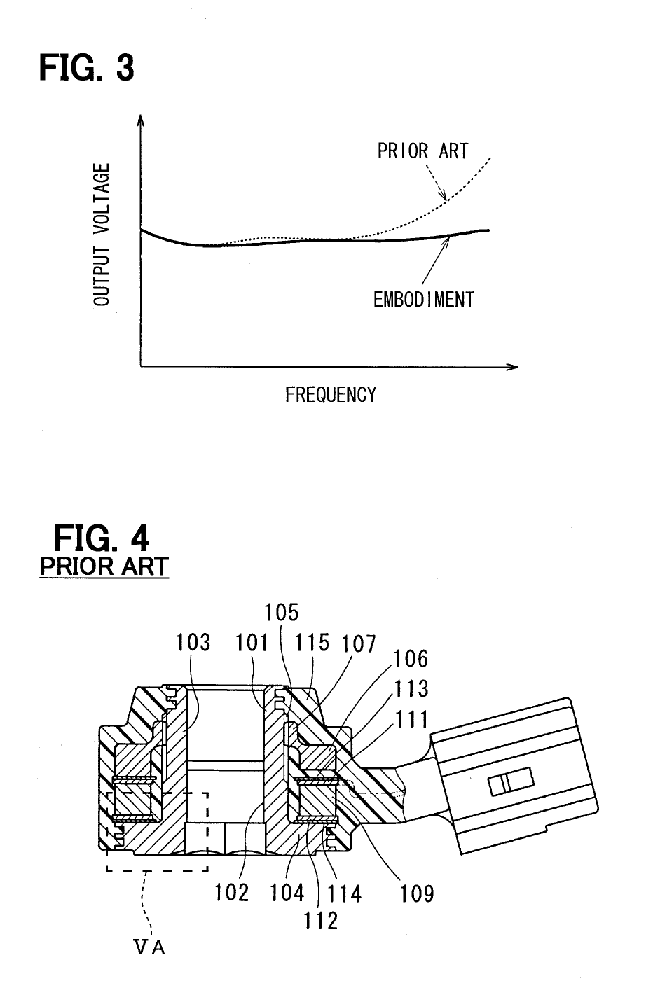

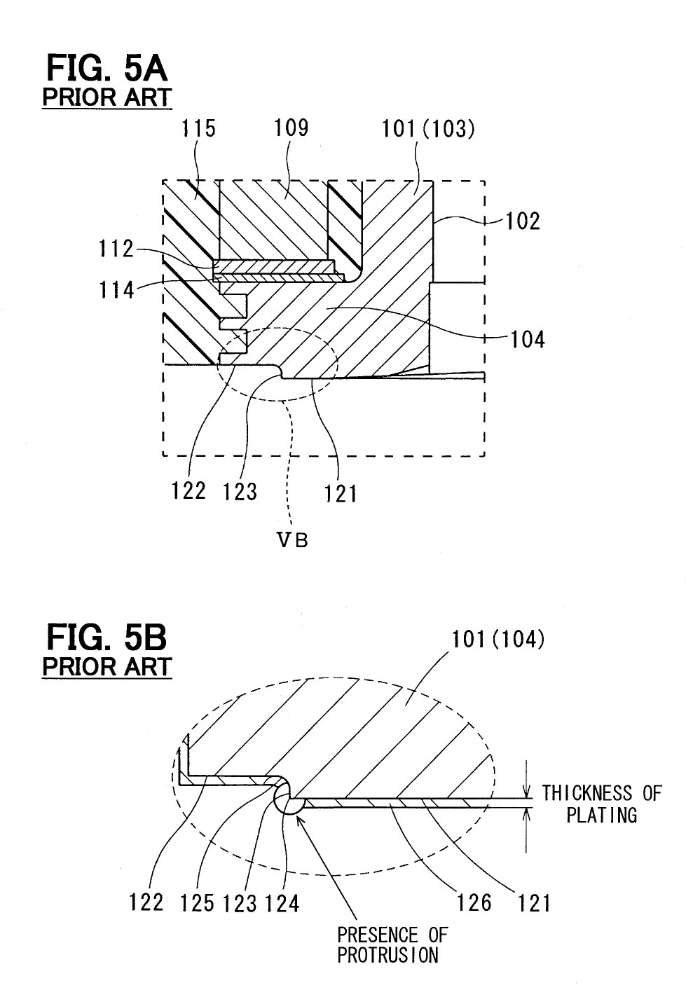

An embodiment of the present disclosure will be described with reference to FIGS. 1 to 3. FIGS. 1 to 2B show a mounting structure of a knock sensor of the present embodiment. FIG. 3 shows a relationship between a vibration frequency and an output voltage of the knock sensor.

A knocking sensing apparatus of the present embodiment includes a nonresonant knock sensor and an engine control device (an electronic control unit that will be hereinafter referred to as an ECU). The ECU senses knocking of an internal combustion engine 100 based on a knock sensor output signal (an electrical signal, such as a voltage signal), which is outputted from the knock sensor in response to vibration generated from the engine 100.

The knock sensor is secured to a mounting seat surface 2 of a cylinder block 1 of the engine 100 with a bolt 3. The bolt 3 is a tightening fixture, which fixes the knock sensor to the mounting seat surface 2 of the cylinder block 1 through tightening of the bolt 3 against the cylinder block 1 of the engine 100.

The knock sensor includes a sensor main body 10, a base (sensor support body) 5, a weight 6 and a sensor connector 7. The sensor main body 10 includes a lead-zirconate-titanate (PZT) element 4 that outputs a knock sensor output signal, which corresponds to the vibration of the engine 100, to an external device(s) also referred to as an external circuit(s), such as the ECU and an electric power source circuit. The base 5 is configured into a cylindrical tubular form and supports the sensor main body 10. The weight 6 and the base 5 clamp the sensor main body 10 therebetween. The sensor connector 7 electrically connects the PZT element 4 to the external device(s).

The base 5 includes a sleeve 11 and a flange 12. The sleeve 11 is configured into a cylindrical tubular form that linearly extends in a tightening direction (installation direction) of the bolt 3 that is tightened against the cylinder block 1 of the engine 3. The tightening direction of the bolt 3 coincides with an axial direction of the bolt 3, which is also an axial direction of the sensor main body 10. The flange 12 is configured into an annular form that outwardly extends in a radial direction, which is perpendicular to the tightening direction (axial direction) of the bolt 3.

A male thread 14 is formed in an outer peripheral surface of the sleeve 11. A nut 13, which is formed integrally with the weight 6 and has a female thread, is threadably tightened against the male thread 14.

A bolt receiving hole 15, which has a circular cross-section, is formed through the sleeve 11 and the flange 12 to axially receive the bolt 3. The bolt 3 has a male-threaded shaft portion 3a, which is threadably engaged with a threaded hole (female-threaded hole) 2a of the cylinder block 1, which is formed in the mounting seat surface 2. Thereby, the knock sensor of the present embodiment forms a center hole type knock sensor, in which the bolt receiving hole 15 extends at the center of the sensor constituent components (e.g., the sensor main body 10, the base 5 and the weight 6). Details of the base 5 will be discussed later.

The sensor main body 10 includes the PZT element 4 as its main component. The sensor main body 10 also includes a first electrode plate (also referred to as a first electrode) 21, a second electrode plate (also referred to as a second electrode) 22, a first dielectric plate (also referred to as a first insulator plate or a first dielectric element) 23 and a second dielectric plate (also referred to as a second insulator plate or a second dielectric element) 24.

The PZT element 4 is made of the material (lead-zirconate-titanate), which can generate the piezoelectric effect. In place of the PZT element 4, there may be alternatively provided another type of piezoelectric element that is made of another type of material, which can generate the piezoelectric effect, and this material may be, for example, ceramics (e.g., barium titanate), a crystal material (e.g., quartz) or an organic material (e.g., polyvinylidene fluoride).

The PZT element 4 is placed at an upper end surface (upper surface) side of the flange 12 of the base 5 in FIG. 1. The PZT element 4 is a sensing element (measuring element), which senses axial vibration transmitted from the cylinder block 1 to the PZT element 4 through the base 5 and outputs a corresponding knock sensor output signal (voltage signal), which corresponds to the sensed vibration.

The first electrode plate 21 is an electrode, which is placed to contact one axial end portion (one axial end surface) of the PZT element 4. Thereby, the first electrode plate 21 is electrically connected to the one axial end portion of the PZT element 4.

The second electrode plate 22 is an electrode, which is placed to contact the other axial end portion (the other axial end surface) of the PZT element 4 that is opposite from the one axial end portion of the PZT element 4. Thereby, the second electrode plate 22 is electrically connected to the other axial end portion of the PZT element 4.

The first dielectric plate 23 is a dielectric body (insulator body, dielectric sheet), which is configured into an annular sheet form and is placed to contact the first electrode plate 21 and to electrically insulate between the weight 6 and the first electrode plate 21.

The second dielectric plate 24 is a dielectric body (insulator body, dielectric sheet), which is configured into an annular sheet form and is placed to contact the second electrode plate 22 and to electrically insulate between the flange 12 of the base 5 and the second electrode plate 22.

The weight 6 is configured into an annular form and is made of iron-based metal (e.g., carbon steel). The weight 6 is configured into the annular form by, for example, one or more of a casting process, a forging process, a press process, a cutting process and a grinding process. With reference to FIG. 1, the nut 13, which is configured into an annular form, is formed integrally with an upper portion of the weight 6. An inner peripheral surface of the nut 13 has the female thread, which is threadably engaged with the male thread 14 formed in the sleeve 11 of the base 5.

The nut 13 has a polygonal cross section (e.g., a hexagonal cross section). In other words, an outer peripheral surface of the nut 13 is configured into a polygonal form (e.g., a hexagonal form). Therefore, the nut 13 can be securely fixed to the sleeve 11 of the base 5 with a tool (e.g., a wrench) by threadably tightening the female thread of the nut 13 against the male thread 14 of the sleeve 11 of the base 5.

The weight 6 is provided to apply a load against the PZT element 4 by clamping the PZT element 4 between the weight 6 and the flange 12.

The weight 6 has an opposing portion (lower end portion in FIG. 1), which is located on an axial side where an upper end surface of the flange 12 of the base 5 is located. The upper end surface of the flange 12 is located on an axial side, which is axially opposite from the engine 100, more specifically axially opposite from the mounting seat surface 2 of the cylinder block 1 of the engine 100. The opposing portion of the weight 6 is axially opposed to the upper end surface of the flange 12 of the base 5. Hereinafter, the upper end surface of the flange 12 may be also simply referred to as an upper surface of the flange 12. The opposing portion of the weight 6 is axially spaced from the upper end surface of the flange 12 by a predetermined axial distance.

Here, the weight 6 is placed on an upper surface of the first electrode plate 21, which is one end surface of the first electrode plate 21 in the thickness direction of the first electrode plate 21, i.e., in the axial direction of the base 5. The weight 6 is configured into an annular form (or a cylindrical tubular form) that circumferentially surrounds the outer peripheral portion of the sleeve 11.

The sensor connector 7 includes first and second sensor terminals (first and second conductors) 61, 62 and a resin-molded body 32. The first and second terminals 61, 62 are electrically connected to, for example, an A/D converter circuit of the ECU and the electric power source circuit, which are the external circuits, through a plurality of conductive lines (e.g., a wire harness). The resin-molded body 32 holds a sensor lead 51, 52 of each of the first and second sensor terminals 61, 62.

The resin-molded body 32 of the sensor connector 7 includes a resin-filled portion 33, a connector case 34, a terminal receiving portion (a conductor receiving portion) 35 and a sensor covering portion 36, which are formed integrally in the resin-molded body 32. The resin-filled portion 33 is configured into a cylindrical tubular form. The connector case 34 is configured into a quadrangular tube form (e.g., a rectangular or square tube form).

A hood portion of the connector case 34 extends in an engaging direction (a connecting direction), along which the connector case 34 is engaged to, i.e., connected to a corresponding external connector that is connected to the external circuit(s).

The terminal receiving portion 35 is a portion that holds the sensor leads 51, 52 of the first and second sensor terminals 61, 62.

The sensor covering portion 36 is a portion that covers an outer peripheral portion of the sleeve 11 of the base 5 and an outer peripheral portion of the sensor main body 10.

The first and second sensor terminals 61, 62 are securely held in the terminal receiving portion 35 of the resin-molded body 32 by insert molding with the molding material (e.g., synthetic resin having a dielectric property).

The first sensor terminal 61 includes the first electrode plate 21 and the sensor lead 51. The first electrode plate 21 overlaps and contacts the one axial end portion (one axial end surface) of the PZT element 4, which is located on the one end side in the axial direction (the pressing direction of the PZT element 4). The sensor lead 51 of the first sensor terminal 61 extends radially outward from the first electrode plate 21. The sensor lead 51 of the first sensor terminal 61 is a first terminal portion, which is connected to the external circuit(s).

The second sensor terminal 62 includes the second electrode plate 22 and the sensor lead 52. The second electrode plate 22 overlaps and contacts the other axial end portion (the other axial end surface) of the PZT element 4, which is located on the other end side in the axial direction (the pressing direction of the PZT element 4). The sensor lead 52 of the second sensor terminal 62 extends radially outward from the second electrode plate 22. The sensor lead 52 of the second sensor terminal 62 is a second terminal portion, which is connected to the external circuit(s).

The sensor lead 51 of the first sensor terminal 61 and the sensor lead 52 of the second sensor terminal 62 are insert molded in the terminal receiving portion 35 of the resin-molded body 32. Furthermore, a distal end portion of the sensor lead 51 of the first sensor terminal 61 and a distal end portion of the sensor lead 52 of the second sensor terminal 62 are exposed in an inside space that is formed in an inside of the connector case 34 of the resin-molded body 32.

The sensor lead 51 of the first sensor terminal 61 and the sensor lead 52 of the second sensor terminal 62 are electrically connected with each other through a resistor (resistance element) 37.

The PZT element 4, the first and second electrode plates 21, 22 and the first and second dielectric plates 23, 24 are respectively configured into an annular form (or a cylindrical tubular form), which circumferentially extends and surrounds the outer peripheral portion of the sleeve 11 of the base 5 and is located on the radially outer side of the sleeve 11 of the base 5.

The first dielectric plate 23, the first electrode plate 21, the PZT element 4, the second electrode plate 22 and the second dielectric plate 24 are arranged one after another in the axial direction in this order from the weight 6 side and are clamped between the flange 12 of the base 5 and the opposing portion of the weight 6. By adjusting the amount of thread engagement (by adjusting an engaging position) of the weight 6 against the male thread 14 of the sleeve 11 of the base 5, the amount of load, which is applied to the first dielectric plate 23, the first electrode plate 21, the PZT element 4, the second electrode plate 22 and the second dielectric plate 24, which are clamped between the flange 12 of the base 5 and the opposing portion of the weight 6, is adjusted.

The outer peripheral portions of the base 5, the PZT element 4, the weight 6, the first and second electrode plates 21, 22 and the first and second dielectric plates 23, 24 are covered with the sensor covering portion 36 of the resin-molded body 32.

A plurality of radial grooves (radially extending grooves or crisscross groove) 39 is formed in a lower surface of the weight 6 (an annular end surface of the weight 6 located on the PZT element 4 side) to radially communicate between the inner peripheral portion and the outer peripheral portion of the weight 6. Thereby, in the molding process, the molding resin material, which forms the resin-molded body 32, also fills a cylindrical gap that is radially defined between the inner peripheral portions of the sensor main body 10 (including the PZT element 4) and the weight 6 and the outer peripheral surface of the sleeve 11, so that the resin filled portion 33 is formed.

Here, the nonresonant knock sensor of the present embodiment is used after being installed such that the lower surface of the base 5, which is made of the iron-based metal (e.g., carbon steel), contacts the mounting seat surface 2 of the cylinder block 1 of the engine 100. In this way, the base 5 is electrically connected to the cylinder block 1. Furthermore, the weight 6, which is directly installed to the sleeve 11 of the base 5, is also electrically connected to the cylinder block 1 through the base 5.

Therefore, in the nonresonant knock sensor of the present embodiment, the PZT element 4 and the first and second electrode plates 21, 22 are electrically insulated from both of the base 5, which supports the sensor main body 10 (including the PZT element 4), and the weight 6, which applies the load to the PZT element 4, through use of the first and second dielectric plates 23, 24 that are the components of the sensor main body 10. Here, the first dielectric plate 23 electrically insulates between the weight 6 and the first electrode plate 21, and the second dielectric plate 24 electrically insulates between the flange 12 of the base 5 and the second electrode plate 22.

The molding material (the resin-filled portion 33), which has the dielectric property, fills the cylindrical gap, which is radially defined between the inner peripheral portions of the sensor main body 10 (including the PZT element 4) and the weight 6 and the outer peripheral surface of the sleeve 11. Thereby, the molding material (the resin-filled portion 33) limits electrical connection of the PZT element 4 and the first and second electrode plates 21, 22, to the sleeve 11 of the base 5.

Next, details of the base 5 of the present embodiment will be described with reference to FIGS. 1 to 3.

The base 5 is configured into a cylindrical tubular form and is made of the iron-based metal (e.g., carbon steel). The base 5 includes the sleeve 11 and the flange 12.

The male thread 14, which is threadably engaged with the female thread of the nut 13, is formed in the outer peripheral surface of the sleeve 11. The bolt receiving hole 15 is formed to extend through the sleeve 11. A seat surface 16, which is configured into an annular form, is formed in one axial end surface of the sleeve 11. The seat surface 16 circumferentially extends around an opening of the bolt receiving hole 15 of the sleeve 11. A head of the bolt 3 is seated against the seat surface 16.

The weight 6, the first dielectric plate 23, the first electrode plate 21, the PZT element 4, the second electrode plate 22 and the second dielectric plate 24 are fitted to the outer peripheral portion of the sleeve 11 in this order from the one axial end side toward the other axial end side of the sleeve 11 (i.e., from the upper side to the lower side in FIG. 1).

In the base 5, in order to increase the tightness of contact between the resin-molded body 32 and the base 5, the base 15 has a plurality of circumferential grooves 17 and a plurality of circumferential grooves 18. The circumferential grooves 17 are radially inwardly recessed in the outer peripheral surface of the one axial end portion of the sleeve 11 (the upper end portion of the base 5 in FIG. 1), and the circumferential grooves 18 are radially inwardly recessed in the outer peripheral surface of the flange 12 (the lower end portion of the base 5 in FIG. 1).

The flange 12 of the base 5 is provided in the other axial end portion of the sleeve 11. A base bottom surface (hereinafter referred to as a lower surface of the base 5) is formed in a lower end surface of the flange 12, which is located on the side where the mounting seat surface 2 of the cylinder block 1 is located.

The lower surface of the base 5 includes a seat-surface-side contact surface 41 and a seat-surface-side relief surface 42. The seat-surface-side contact surface 41 is configured into an annular form and contacts the mounting seat surface 2 of the cylinder block 1. More specifically, the seat-surface-side contact surface 41 circumferentially extends around the peripheral edge of the opening of the bolt receiving hole 15 and contacts the mounting seat surface 2. The seat-surface-side relief surface 42 is configured into an annular form and defines a small annular gap (minute gap) between the seat-surface-side relief surface 42 and the mounting seat surface 2 of the cylinder block 1. Specifically, the seat-surface-side relief surface 42 circumferentially extends along the seat-surface-side contact surface 41. The seat-surface-side relief surface 42 is axially recessed away from the seat-surface-side contact surface 41 and defines the gap between the seat-surface-side relief surface 42 and the mounting seat surface 2. An annular step 43 is radially placed between the seat-surface-side contact surface 41 and the seat-surface-side relief surface 42 and circumferentially extends along the seat-surface-side contact surface 41 and the seat-surface-side relief surface 42 in the base 5.

A rust and corrosion protective coating (a zinc plating) 8, which has a predetermined coating thickness (e.g., 10 μm), is applied on the entire surface of the base 5 to improve the rust resistivity and the corrosion resistivity of the iron-based metal that is the base metal of the base 5.

The seat-surface-side contact surface 41 is formed along the peripheral edge (the circumferential edge) of the opening of the bolt receiving hole 15. The seat-surface-side contact surface 41 is formed as a planar surface that makes surface-to-surface contact with the mounting seat surface 2 of the cylinder block 1 when the male-threaded shaft portion 3a of the bolt 3 is tightly threaded into the female-threaded hole 2a of the cylinder block 1. The seat-surface-side contact surface 41 axially protrudes from the seat-surface-side relief surface 42 by the one step toward the mounting seat surface 2 of the cylinder block 1. The seat-surface-side contact surface 41 has an outer diameter that is slightly larger than an outer diameter of the head of the bolt 3.

The seat-surface-side relief surface 42 is formed to circumferentially surround the seat-surface-side contact surface 41 on the radially outer side of the seat-surface-side contact surface 41. The seat-surface-side relief surface 42 is axially recessed from the seat-surface-side contact surface 41 by the one step toward the side that is axially opposite from the mounting seat surface 2. The seat-surface-side relief surface 42 has an inner diameter that is slightly larger than the outer diameter of the head of the bolt 3.

The base 5 of the present embodiment is formed to have the sleeve 11, the flange 12, the seat-surface-side contact surface 41, the seat-surface-side relief surface 42 and the step 43 by, for example, one or more of a casting process, a forging process, a cutting process and a grinding process.

A corner 44 between the seat-surface-side contact surface 41 and the step 43 is arcuately chamfered to form a curved protruding surface (an arcuately curved surface that protrudes outwardly toward the mounting seat surface 2). That is, a cross-sectional area of the corner 44, which is formed between the seat-surface-side contact surface 41 and the step 43 of the base 5, is arcuately curved (forming the arcuately curved surface having a predetermined radius of curvature R (e.g., Ø 0.5 mm or larger) to enable limiting of the bulging, i.e., the protruding of the zinc plating 8.

Next, a manufacturing method of the knock sensor according to the present embodiment will be described.

First of all, the iron-based metal, such as the carbon steel, is forged to form an ingot, from which the base (the sensor support body) 5 that supports the sensor main body 10 is formed. Then, this ingot is placed into a forging die and is cold forged (or hot forged). In this way, a forged article (base metal), which has the cylindrical tubular sleeve 11 and the annular flange 12, is formed.

Next, a cutting process is performed on the forged article, so that the male thread 14, which will be threadably engaged with the nut 13 formed integrally with the weight 6, is formed in the outer peripheral surface of the sleeve 11. Here, it should be noted that the circular bolt receiving hole 15, through which the bolt 3 is received, may be formed by performing the cutting process (e.g., a drilling process) on the forged article.

Furthermore, the seat-surface-side contact surface 41 is formed in a lower surface of the forged article by, for example, a cutting process and/or a grinding process in a lower surface of a cylindrical tubular protrusion (a portion that protrudes downward from the seat-surface-side relief surface 42 toward the engine 100), which is formed in the lower surface of the forged article and is concentric to the bolt receiving hole 15.

Next, the zinc plating 8 having the predetermined coating thickness (plating thickness) is formed by a galvanizing process (a plating process) over the entire surface of the base metal, which is produced from the forged article by the cutting process and/or the grinding process. In this way, the cylindrical tubular base 5 is formed.

The zinc plating 8 is a plating, i.e., a coating (a rust protective coating or a corrosion protective coating, which is rust resistant or corrosion resistant, respectively) that is made of zinc or a zinc alloy and has a coating thickness (a plating thickness) of, for example, 2 μm to 30 μm or alternatively 3 μm to 15 μm. The zinc plating 8 may be formed by, for example, a regular electroplating process (an electrolytic zinc plating process). Alternatively, the zinc plating may be formed on the base metal of the base 5 by, for example, acid bath (e.g., sulfate bath, ammoniac bath, potassium bath) or alkaline bath (alkaline cyanide-free bath, alkaline cyanide bath).

When the coating thickness of the zinc plating 8 is less than 2 μm, the rust resistance and the corrosion resistance of the base (the base metal) 5 made of the iron-based metal (e.g., the carbon steel) cannot be sufficiently maintained.

Furthermore, when the coating thickness of the zinc plating 8 is larger than 30 μm, the zinc plating 8 can be easily peeled off, and the required time period of the plating process is disadvantageously lengthened.

Here, the surface of the zinc plating (layer) 8 may be coated with a chromate conversion coating, which includes a metal constituent that can be more easily oxidized than the zinc. In this way, it is possible to avoid, for example, the corrosion and the discoloration of the zinc plating 8. The chromate coating may have a coating thickness of 0.05 μm to 0.18 μm and may be formed by using a working solution, which forms a trivalent chromate conversion coating.

Next, an assembling procedure (an assembling method) of the knock sensor according to the present embodiment will be described.

First of all, the second dielectric plate 24, the second electrode plate 22, the PZT element 4, the first electrode plate 21, the first dielectric plate 23 and the weight 6 are stacked in this order over the upper surface (the mounting surface) of the flange 12 of the base 5 from the lower end side (the other axial end side) toward the upper end side (the one axial end side) to surround the outer peripheral portion of the sleeve 11 of the base 5. At this time, the sensor lead 51 of the first sensor terminal 61 and the sensor lead 52 of the second sensor terminal 62 are electrically connected with each other through the resistor 37.

Next, the female thread of the nut 13, which is formed integrally with the weight 6, is threadably engaged with the male thread 14 of the sleeve 11, so that the sensor main body 10 (the second dielectric plate 24, the second electrode plate 22, the PZT element 4, the first electrode plate 21 and the first dielectric plate 23) is securely clamped between the upper surface of the flange 12 of the base 5 and the opposing portion of the weight 6.

Thereafter, the base 5 and the sensor main body 10 are set in an injection molding die. Then, the molding resin material is injection molded in the injection molding die such that the molding resin material covers the base 5 and the sensor main body 10, and thereby the resin-molded body 32 is formed. In this way, the nonresonant knock sensor is manufactured.

Here, the knock sensor is formed such that the lower surface (the seat-surface-side contact surface 41, the seat-surface-side relief surface 42 and the step 43) of the base 5 is exposed from the other axial end surface, i.e., the engine 100 side end surface (the other axial end surface, i.e., the lower surface 45 in FIG. 2A) of the resin-molded body 32, and the one axial end portion of the sleeve 11 of the base 5 is exposed from the one axial end surface (the upper end surface in FIG. 1) of the resin-molded body 32, which is axially opposite from the engine 100.

The knock sensor, which is manufactured in the above described manner, is installed to the cylinder block 1 as follows. That is, the bolt 3 is inserted through the bolt receiving hole 15, which extends through the sensor main body 10 and the base 5. Then, the male thread of the male-threaded shaft portion 3a of the bolt 3 is threadably tightened into the female-threaded hole 2a of the cylinder block 1, so that the lower surface (particularly the seat-surface-side contact surface 41) of the base 5 makes the surface-to-surface contact with the mounting seat surface 2 of the cylinder block 1. Thereby, the knock sensor is fixed to the cylinder block 1.

Next, an operation of the knock sensor according to the present embodiment will be briefly described with reference to FIGS. 1 to 3.

The knock sensor of the present embodiment is fixed to the mounting seat surface 2 of the cylinder block 1 of the engine 100 by the bolt 3, which is received through the sensor main body 10 and the base 5 in the axial direction (the tightening direction, i.e., installation direction of the bolt 3).

The vibration, which is generated in the engine 100, is conducted to the flange 12 of the base 5 of the knock sensor that is installed to the cylinder block 1.

The vibration of the engine 100, which is conducted to the base 5, is conducted to the weight 6 through the sleeve 11 of the base 5.

Thereafter, the vibration of the engine 100, which is conducted to the weight 6, is amplified by the weight 6 and is then conducted to the PZT element 4.

Specifically, the knock sensor is installed such that the lower surface of the base 5 contacts the mounting seat surface 2 of the cylinder block 1. In this way, the base 5 and the weight 6, which contact with each other, are vibrated together synchronously with the vibration of the engine 100.

At this time, a force, which is proportional to the vibration acceleration generated at the engine 100, is applied to the PZT element 4. Thereby, a voltage, which is proportional to a distortion of the PZT element 4 caused by the vibration, is generated between the first electrode plate 21 and the second electrode plate 22 located on the opposite axial sides, respectively, of the PZT element 4. That is, the stress, which is applied to the PZT element 4, is converted into the electrical signal, i.e., the knock sensor output signal (voltage signal).

Therefore, the voltage signal, which has a waveform that is similar to that of the vibration of the engine 100, is outputted externally through the sensor leads 51, 52 of the first and second sensor terminals 61, 62.

Then, the ECU receives (obtains) the voltage signal, which is outputted from the knock sensor. When this voltage signal exceeds a predetermined value, the ECU determines that the knocking vibration is generated in the engine 100 and executes a retarding control operation of spark plugs and an injection timing control operation of fuel injectors.

Next, advantages of the present embodiment will be described.

As discussed above, according to the present embodiment, the cross section of the corner 44 between the seat-surface-side contact surface 41 of the lower surface of the base 5 and the step 43 is configured into the arcuately curved protruding surface having the radius of curvature R. Thereby, the bulging, i.e., the protrusion of the zinc plating 8 at the corner 44 of the lower surface of the base 5 can be advantageously limited. In this way, the seat-surface-side contact surface 41 of the base 5 can be made as the planar surface (flat surface), so that the mounting of the knock sensor to the mounting seat surface 2 of the cylinder block 1 is stabilized.

As a result, it is possible to limit the phenomenon (resonance phenomenon), which significantly increases the output signal (the voltage signal) of the knock sensor that is outputted externally. Thereby, the variations in the output signal of the knock sensor in the specific frequency range (e.g., the high frequency range) are reduced. In this way, it is possible to limit the occurrence of the abnormality in the output voltage of the knock sensor (the output voltage relative to the vibration frequency) in the specific frequency range (e.g., the high frequency range). As a result, the output voltage of the knock sensor becomes the generally flat output voltage as indicated by a solid line in FIG. 3.

The knock sensor of the present embodiment is the nonresonant knock sensor that is fixed such that the lower surface of the flange 12 of the base 5 (particularly the seat-surface-side contact surface 41) contacts the mounting seat surface 2 of the cylinder block 1.

FIG. 3 shows the result of the experiment, indicating a voltage waveform (a sensor output waveform) of a sensor output signal of the knock sensor of the prior art and a voltage waveform (a sensor output waveform) of an sensor output signal of the knock sensor of the present embodiment. In FIG. 3, the axis of abscissas indicates the vibration frequency, and the axis of ordinates indicates the sensor output voltage.

The voltage waveform, which is indicated by the solid line in FIG. 3, is the sensor output waveform of the knock sensor of the present embodiment. Furthermore, the voltage waveform, which is indicated by the dotted line in FIG. 3, is the sensor output waveform of the knock sensor of the prior art.

As is understood from the result of this experiment, the sensor output waveform of the knock sensor of the prior art shows the relatively large amount of change in the output voltage relative to the change in the vibration frequency in the high frequency range. In contrast, the sensor output waveform of the knock sensor of the present embodiment shows the relatively small amount of change in the output voltage relative to the change in the vibration frequency even in the high frequency range.

In view of the above result, the output voltage of the knock sensor of the present embodiment does not become significantly large in the specific frequency range (particularly in the high frequency range), and the output voltage of the knock sensor of the present embodiment becomes generally flat relative to the vibration frequency (i.e., the output voltage having the gradient of the voltage waveform, which is generally constant or is not changed rapidly). Therefore, the knock sensor of the present embodiment can advantageously limit the erroneous sensing of the vibration caused by the knocking of the engine 100. As a result, the knocking sensing accuracy can be improved.

Thus, the output voltage of the knock sensor can be improved, and thereby the sensing accuracy for sensing the knocking of the engine 100 can be improved.

Furthermore, the sensing accuracy for sensing the knocking of the engine 100 can be improved throughout the wide frequency range. Therefore, it is possible to significantly increase the knocking sensing range.

Also, according to the present embodiment, the variations in the output voltage in the specific frequency range (e.g., the high frequency range) can be reduced, as discussed above. Therefore, it is possible to reduce the abnormality in the output signal, which is outputted externally from the knock sensor, i.e., it is possible to reduce the abnormality in the output signal (the voltage signal), which is outputted externally from the knock sensor.

Now, modifications of the above embodiment will be described.

In the above embodiment, the zinc plating 8, which improves the rust resistance and/or the corrosion resistance of the base 5, is used as the rust protective and/or corrosion protective coating formed over the entire surface of the base 5, which serves as the sensor support body. Alternatively, a zinc chromate plating, which improves the rust resistance and/or the corrosion resistance of the base 5, can be used as the rust protective and/or corrosion protective coating formed over the entire surface of the sensor support body.

Also, a rust protective film or a corrosion protective film, which improves the rust resistance or the corrosion resistance of the zinc plating, may be formed on the surface of the zinc plating 8.

In the above embodiment, the corner 44, which is formed in the lower surface of the flange 12 of the base 5, is chamfered to form the arcuately curved protruding surface, which has the radius of curvature R (e.g., Ø 0.5 mm or larger). Alternatively, the corner 44, which is formed in the lower surface of the flange 12 of the base 5, may be tapered to form a tapered surface, thereby making the corner 44 that is configured to define an obtuse angle (the cross section of the corner 44 defining the obtuse angle or an obtuse shape).

In such a case, the tapered surface (slope surface), which is formed by the tapering, is angled at a predetermined taper angle (generally 0°<θ≦010°) relative to the seat-surface-side contact surface 41 and is angled at a predetermined angle (generally 0°<θ≦010°) relative to the step 43.

Additional advantages and modifications will readily occur to those skilled in the art. The present disclosure in its broader terms is therefore not limited to the specific details, representative apparatus, and illustrative examples shown and described.

1. A knock sensor for an internal combustion engine, the knock sensor comprising:
a sensor main body that includes a piezoelectric element, wherein the piezoelectric element outputs a signal in response to vibration generated from the internal combustion engine; and
a sensor support body that is configured into a tubular form and supports the sensor main body, wherein:
the sensor support body has a bolt receiving hole, which extends through the sensor support body and receives a bolt to fix the sensor support body against a seat surface of the internal combustion engine with the bolt;
a protective coating, which is rust resistant or corrosion resistant, is formed on an entire surface of the sensor support body;
the sensor support body includes:
a contact surface that circumferentially extends around a peripheral edge of an opening of the bolt receiving hole and contacts the seat surface of the internal combustion engine;
a relief surface that circumferentially extends along the contact surface, wherein the relief surface is axially recessed away from the contact surface and defines a gap between the relief surface and the seat surface of the internal combustion engine; and
a step that is radially placed between the contact surface and the relief surface and circumferentially extends along the contact surface and the relief surface; and
a surface of a corner between the contact surface and the step is curved or defines an obtuse angle.

2. The knock sensor according to claim 1, wherein the protective coating is a zinc plating that is rust resistant or corrosion resistant.

3. The knock sensor according to claim 1, wherein the sensor support body has a flange that contacts the seat surface of the internal combustion engine when the sensor support body is fixed to the seat surface with the bolt.

4. The knock sensor according to claim 1, wherein the sensor support body has a flange that extends radially outward in a radial direction, which is perpendicular to an axial direction of the bolt.

5. The knock sensor according to claim 4, further comprising a weight that is threadably engaged with and is secured to the sensor support body, wherein the weight clamps the sensor main body between the weight and the flange.

6. The knock sensor according to claim 4, further comprising a weight that is threadably engaged with and is secured to the sensor support body, wherein the weight urges the sensor main body toward the flange.

7. The knock sensor according to claim 1, wherein the contact surface of the sensor support body makes surface-to-surface contact with the seat surface of the internal combustion engine when the sensor support body is fixed to the seat surface with the bolt.

8. The knock sensor according to claim 1, wherein the contact surface protrudes from the relief surface toward the seat surface of the internal combustion engine.

9. The knock sensor according to claim 1, further comprising a connector that connects the piezoelectric element to an external device.

10. The knock sensor according to claim 9, wherein the connector includes:
a first conductor that is electrically connected to one axial end portion of the piezoelectric element;
a second conductor that is electrically connected to the other axial end portion of the piezoelectric element, which is axially opposite from the one axial end portion of the piezoelectric element; and
a molded body that is made of resin and holds the first conductor and the second conductor.

11. The knock sensor according to claim 1, wherein the sensor main body includes:
a first electrode that contacts one axial end surface of the piezoelectric element;
a second electrode that contacts the other axial end surface of the piezoelectric element, which is axially opposite from the one axial end surface of the piezoelectric element;
a first dielectric element that contacts an end surface of the first electrode, which is axially opposite from the piezoelectric element, to axially hold the first electrode between the first dielectric element and the piezoelectric element; and
a second dielectric element that contacts an end surface of the second electrode, which is axially opposite from the piezoelectric element, to axially hold the second electrode between the second dielectric element and the piezoelectric element.

12. The knock sensor according to claim 1, wherein the surface of the corner between the contact surface and the step is chamfered to form a curved surface that protrudes outwardly.
